(19) United States
(12) Patent Application Publication
(10) Pub. No.: US 2005/0003713 A1
(43) Pub. Date: Jan. 6, 2005

(54) Catchable plug

(76) Inventor: Jurgen Lappohn, Gammelshausen (DE)

Correspondence Address: WILLIAM COLLARD;COLLARD & ROE, P.C., 1077 NORTHERN BOULEVARD, ROSLYN, NY, 11576, US

(21) Appl. No.: 10/883,514

(22) Filed: Jul. 1, 2004

(30) Foreign Application Priority Data
Jul. 3, 2003 (DE) 103 29 894

(51) Int. Cl. H01R 13/627

(52) U.S. Cl. 439/701

(57) ABSTRACT

A plug having a plug housing and a shielding plate. The plug is fixed in place on a circuit board with at least one attachment device. This attachment device can be attached to the plug housing. To attach the plug to another component, there is a catch element formed on the attachment device which passes through a corresponding recess in said shielding plate in the plug.

### CROSS REFERENCE TO RELATED APPLICATIONS

This application hereby claims priority from German application serial no. DE 10329894.0 filed on Jul. 3, 2003 wherein priority is hereby claimed under 35 U.S.C. 119.

### BACKGROUND OF THE INVENTION

A catchable plug wherein the plug can be in the form of a plug element wherein an optical contact can be produced between the plug and a plug that is configured to be complementary to it. The term plug can be understood to mean all plug connection elements such as plugs, plug connectors, male and female multipoint plugs, wherein electrical contacts can be produced between the plug and a plug that is configured to be complementary to it. Using these plugs, electrical or optical components can be used for transmitting signals or energy between different electrical or optical components.

Other attachment devices are known in the art. For example, DE 102 43 407 involves contacts on circuit boards, boards motherboards, backplanes or similar electronic components such as circuit boards wherein these plugs can be connected with a multi-pole cable.

There is a shielding plate that essentially rests flush with its complete surface on the housing of the plug wherein this is preferably connected with the ground for shielding the plug. This ground serves to electrically shield the plug. In this case, the plugs are attached either to other plugs which are configured to be complementary to them using a screw connection, or the plugs are attached to the housing wall of a personal computer using the screw connection so that the electrical or optical contacts of the plug pass through an opening in the housing wall and point outward, so that another plug can be plugged into the housing or into a plug screwed into the housing from the outside.

In this way, to produce a screw connection, corresponding recesses in the shielding plate must be present and wherein additional screw connection elements made from metal must be provided in corresponding recesses in the plastic housing to prevent damage to the plastic housing when loosening and restoring the screw connection using metal screws. This results in a significant increase in the number of components of the known plugs as well as a significant additional assembly effort.

Thus, from this point, a person skilled in the art can structure a plug so that it can be releasably attached to the housing in a simple manner so that the plug production can be simplified.

### SUMMARY OF THE INVENTION

The invention relates to a plug that is not fixed to a housing using a screw connection but rather by using a catch connection. In this way, a plug side catch element is configured on attachment devices and arranged laterally on the housing of the plug. In this case, a plug housing has two symmetrical attachment devices on its narrow sides. To attach the plug to the housing, using for example a TMC plug connector at a corresponding plug-in location, the housing has catch projections and catch lugs in the respective locations.

The recesses in this shielding plate of the plug housing can be arranged on a narrow side of the plug, positioned on the edge to allow the attachment devices to be laterally set into the plug housing. In this case, each plug housing includes catch elements that end flush with the narrow sides of the shielding plate or the assembled plug. Thus, these recesses can be formed in the flat part of a shielding plate so that the attachment devices with the catch are inserted through these recesses.

One of the advantages of this invention is that the number of individual parts of this plug is significantly reduced since there are no additional screws or screw connection elements in the plug. Thus, the production of the plug is significantly simplified and therefore made less expensive. In addition, if the catch elements on the attachment device are sized appropriately, then the connection of this plug can be released wherein the plug can be engaged in a new plug in location. In addition there is no need for additional tools such as screwdrivers to attach the plug to the housing.

In this way, the housing of the plug comprises a plastic injection molded part. In this case there can be a corresponding depression or recess for these electrically or optically conductive contact elements wherein these elements are set into the housing of the plug in a known manner.

In this case, the attachment devices can comprise of metal and or zinc, wherein these attachment devices are produced using a diecasting method.

These attachment devices can provide lateral electrical shielding of the plug housing wherein the attachment device can be soldered onto or pressed onto a circuit board. The structure of the attachment device provides an advantage wherein the catch elements on the attachment device which are formed in one piece with this attachment device have a sufficient permanent elasticity so that the plug can be releasably attached several times at different plug locations. In this case, the attachment devices can be block shaped to demonstrate sufficient stability and absorb forces that act on the plug from the outside.

To arrange the attachment devices in the correct position relative to the plug housing, a plurality of guide pins are formed on the housing wherein these guide pins can be used to engage with corresponding recesses in the attachment devices which are block shaped. These guide pins are formed on one side of the housing wherein each of these guide pins have a different diameter and dimensions to assure that the attachment devices, which have a corresponding recess are set in the correct position. These guide pins can then also be formed on the attachment devices and also in the recesses of the housing.

The catch element on this attachment device can be configured in a hook shape to engage behind a correspondingly configured catch projection, which can be behind a computer housing. In this case, the catch element can be bent slightly back to counter the spring-elastic pull back forces on it.

In another embodiment of the invention, the SMD contact surfaces are formed on attachment devices to solder these attachment devices and also the entire plug onto a circuit board. However, press-in zones can also be formed in this attachment device. To assure an alignment of this plug relative to a circuit board, one of these alignment projections are formed on this attachment device wherein these projections can engage with corresponding recesses or depressions in the circuit board. This design is to prevent the bending of the electrical or optical contacts that project out of the plug housing and that are supposed to be in contact on the circuit board.

To attach the shielding plate on the housing of the plug on this attachment device, a plurality of catch tabs are formed on the shielding plate. These catch tabs can engage corresponding catch depressions in the plug housing or on the attachment device. In this case, the catch tabs can engage behind catch projections. Thus, in an advantageous design, several catch tabs can be affixed on a shielding plate in different positions to assure attachment of the shielding plate on the plug, in a correct position.

For the electrical contact of the attachment device on the shielding plate, a contact arm is formed wherein this arm preferably interacts with the catch tabs of this shielding plate. Thus, the electrically conductive connection between the shielding plate and the attachment device can exist as a ground contact.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a perspective view of a plug;

FIG. 2 is a side perspective view of the plug;

FIG. 3 is a back perspective view of the plug;

FIG. 4 is a bottom perspective view of the plug;

FIG. 5 is a cross sectional view of the plug in; and

FIG. 6 is a side perspective view of the plug.

### DETAILED DESCRIPTION OF PREFERRED EMBODIMENTS

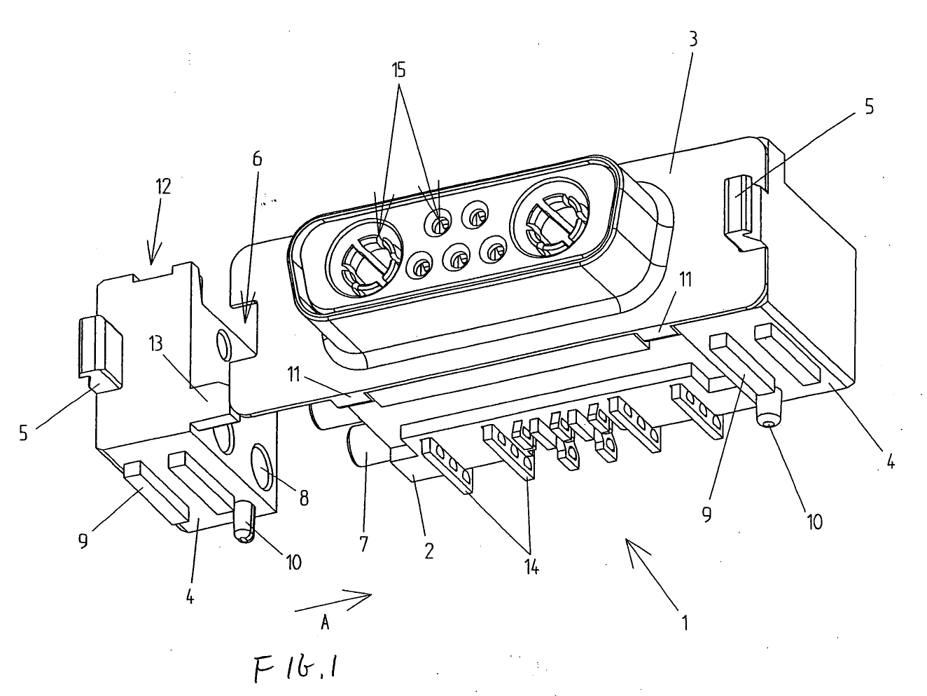

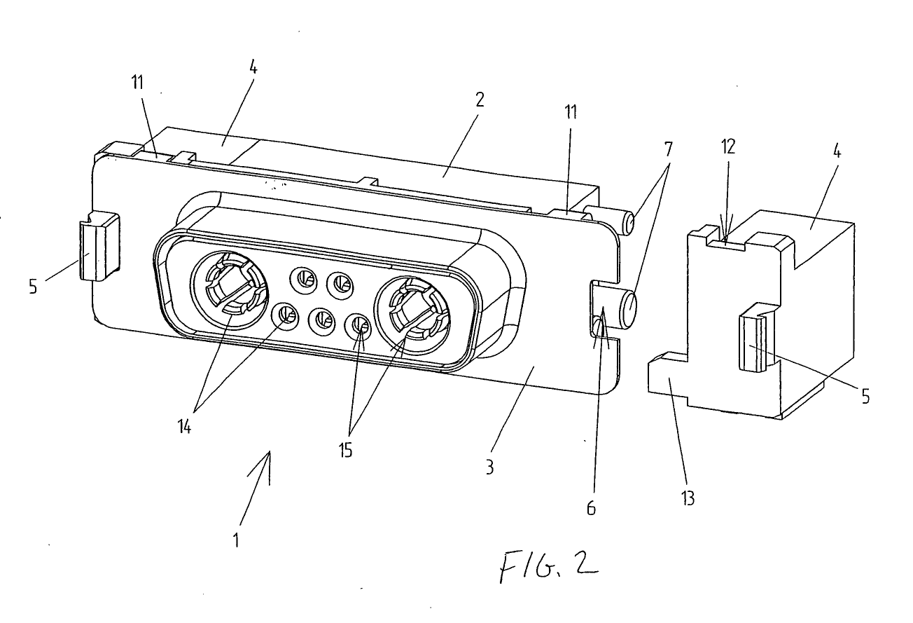

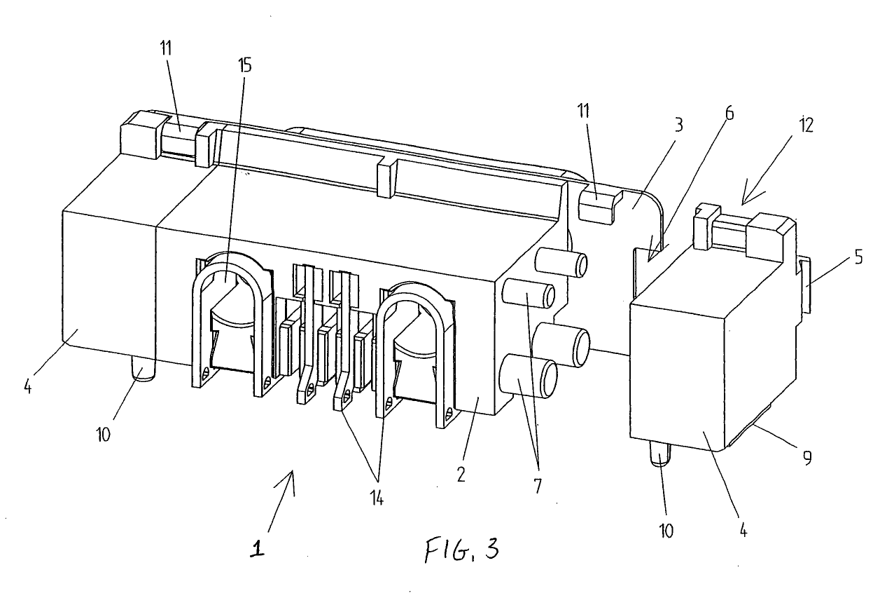

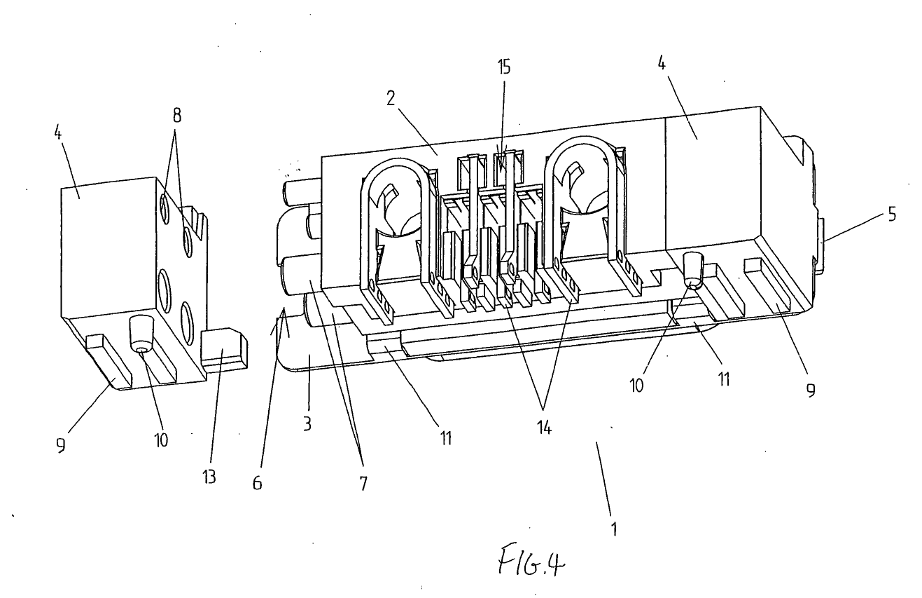

Referring to the drawings, FIG. 1 to 4 show various respective views of the invention wherein there is shown a plug 1 which has a plug housing 2, which is formed from a plastic injection molded part. Plug 1 has a shielding plate 3 made from metal which rests against a front of the plug housing 2 essentially formed in its entire area as a flat area that covers the shielding plate. There are passage openings that are used to accommodate electrical or optical contacts which are formed in the plug housing. In this case, the contacts 14 can be set into plug housing 2 in a known manner and locked in place in this plug housing if necessary.

Electrical or optical signals are transmitted from one electrical or optical element to another using plugs 1. In this case, electrically conductive connections can be produced using these contacts 14. Plugs 1 are attached to circuit boards using two symmetrical attachment devices 2 wherein this attachment takes place by pressing known press in zones on attachment devices 4 into circuit boards which are not shown. These attachment devices can also be soldered in using SMD contact regions 9 which are known to a person skilled in the art, wherein these devices can be soldered onto corresponding contact regions of the circuit board.

Plug 1 is attached in an opening recess of a computer housing with shielding plate 3 wherein with this invention, catch elements 5 are provided on lateral attachment devices 4 to attach plug 1. In this case, catch elements 5 which are configured in a hook shape, are produced in one piece with block shaped attachment devices 4 using zinc diecasting. For this purpose, the computer housing has corresponding catch projections. However corresponding plug connection elements can also be engaged with plug 1.

In this case, guide pins 7 can be used to arrange the attachment devices 4 in the correct position relative to plug housing 2. These guide pins are configured in one piece with plug housing 2 and can be brought into engagement with corresponding depressions 8 in attachment devices 4. In this case, several guide pins 7 are formed on each side of plug housing 2, which can be brought into appropriately sized depressions in the correct position. With this design, attachment devices 4, are pushed into plug housing 2 in a plug-in direction A as shown in this figure by the arrow.

In this case, alignment projections 10 in attachment devices 4, align plug 1 relative to a circuit board to prevent any bending of contacts 14, which project out from housing 2, when plug 1 is sent into a circuit board.

Shielding plate 3 of plug 1 has recesses 6 on its edges to accommodate catch elements 5 which pass through the surface of shielding plate 3 when plug 1 is assembled to allow plug 1 to be fixed in place. Attachment devices 4 of catch elements 5 are designed so that they end flush with the narrow sides of plug 1 as shown in FIGS. 1 to 4. It is also fundamentally possible to have recesses arranged on the surface of shielding plate 3. Thus, catch element 5 of attachment device 4 must be inserted into this recess.

Two attachment devices 4 can be arranged on a plug housing 2 laterally and symmetrically to assure reliable and permanent attachment of plug 1 on another housing or on another plug that would correspond to it.

For the permanent attachment of shielding plate 3 on plug housing 2, attachment device 4 and catch tabs 11 are formed on shielding plate 3, wherein these catch tabs 11 interact with catch depressions 12 on plug housing 2 or on attachment devices 4. In this case, catch tabs 11 are formed on the opposite long sides of shielding plate 3 in each instance wherein a reciprocal distance between catch tabs 11 can be selected to be different on its long two sides to avoid an incorrect setting of shielding plate 3 onto plug housing 2. With this design, catch tabs 11 engage behind catch depressions 12, on the plug housing 2 or on the attachment devices 4. In this case, several catch tabs 11 are formed on a set of opposite long sides of a shielding plate 3 wherein in each instance, a reciprocal distance between each of the catch tabs is selected to be different on these two sides to avoid incorrectly setting the shielding plate 3 onto the plug housing 2. Thus, with this design, catch tabs 11 engage behind catch depressions 12.

To improve an electrical contact between shielding plate 3 and attachment device 4, there are contact arms 13 which are formed on contact device 4. These arms engage catch tabs 11 on shielding plate 3 when plug 1 is assembled. With this design there is a permanent and reliable electrical contact particularly with a ground, to shield plug 1.

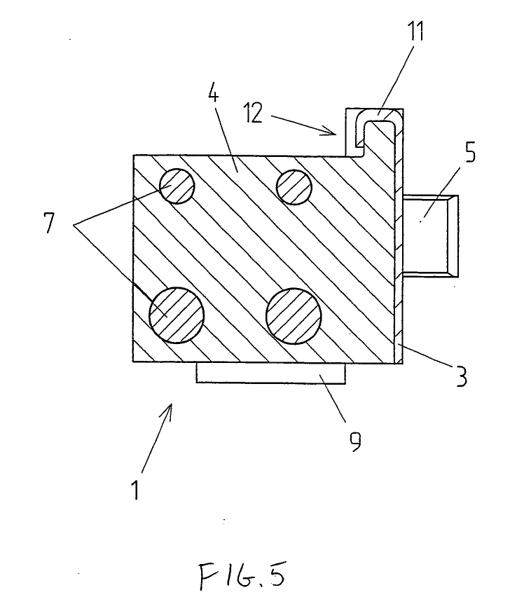

FIG. 5 shows a cross-sectional representation wherein plug 1 can be seen so that guide pins 7 of plug housing 2 are inserted into lateral attachment devices 4. In this case, attachment device 4 has an SMD contact region 9 which are known to persons skilled in the art. Thus, shielding plate 3 of plug 1 is fixed in place on a catch depression 12 of attachment device 4 with catch tab 11. Catch element 5 of attachment device 4 projects beyond a plane of shielding plate 3 and then serves to attach a plug 1 to another corresponding plug or housing.

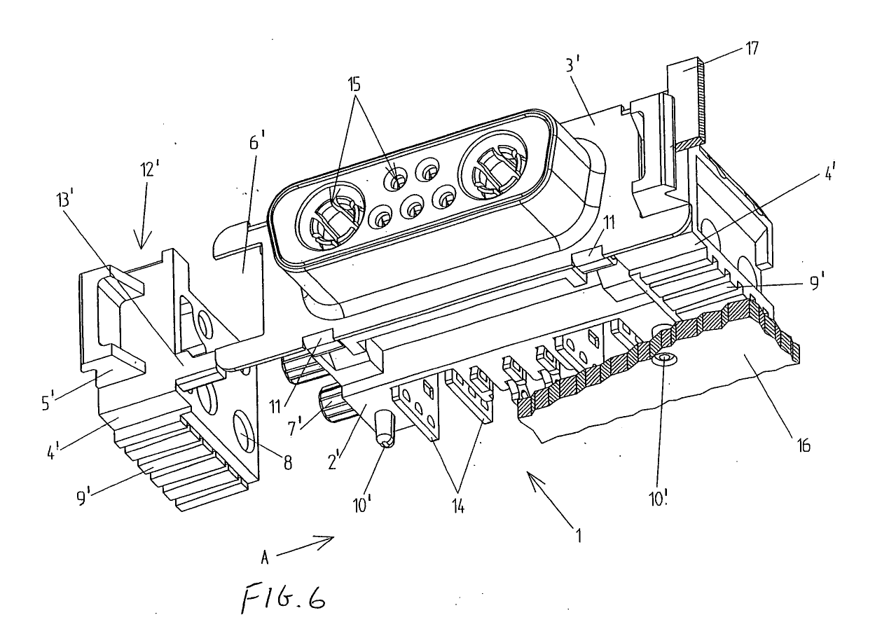

FIG. 6 shows a modified version of plug 1. In this case, these modified parts or regions of components are designated with a same reference numeral in each instance and an appended apostrophe 3′. In this embodiment, attachment device 4′ is configured to have thinner walls, to save this material. An SMD contact region is arranged off-set by a rotation of 90° as compared with a first embodiment variant as shown in FIGS. 1 to 4. In addition, an alignment projection 10′ is set into plug housing 2′ but not on attachment device 4′. In this case, the function assigned to this component or components include catch element 5′ recess 6′ catch depression 12′ and contact arm 13′ which are also configured in a modified manner.

In this condition, circuit board 16 on plug housing 2′ is shown in FIG. 6 as an engagement of catch element 5′ on body 17 of a complementary plug. This also applies for the first embodiment shown in FIG. 1 to 4.

Thus, the design of the present invention creates a plug type connection that can be releasably attached to the housing in a simple manner so that the plug production can be simplified.

Accordingly, while a few embodiments of the present invention have been shown and described, it is to be understood that many changes and modifications may be made thereunto without departing from the spirit and scope of the invention as defined in the appended claims.

1. A plug comprising:
a) a plug housing;
b) at least one shielding plate coupled to said plug housing, said shielding plate having a recess;
c) at least one attachment device that can be attached to said plug housing or a circuit board; and
d) at least one catch element formed on said attachment device wherein said at least one catch element can be used to engage an adjacent device.

2. The plug as in claim 1, wherein said catch element is formed in a hook shape.

3. The plug as in claim 1, wherein said at least one attachment device is disposed on two adjacent faces of said plug housing in a mirror image.

4. The plug as in claim 1, further comprising a plurality of guide pins disposed on said housing and wherein said plug housing has a plurality of depressions.

5. The plug as in claim 1, wherein said at least one attachment device further comprises an SMD contact region.

6. The plug as in claim 1, wherein said attachment device further comprises an alignment projection.

7. The plug as in claim 1, wherein said attachment device is in the form of a zinc diecast.

8. The plug as in claim 1, wherein said attachment device is block-shaped.

9. The plug as in claim 1, wherein said shading plate further comprises catch tabs which interact with catch depressions on said plug housing.

10. The plug as in claim 9, further comprising a contact arm formed on said attachment device which interacts with said catch tab of said shielding plate.

11. The plug as in claim 7, wherein said at least one attachment device is formed integral with said electrical shielding.

12. The plug as in claim 1, wherein said plug housing is formed as plastic.
